(19) United States
(12) Patent Application Publication
(10) Pub. No.: US 2013/0117337 A1
(43) Pub. Date: May 9, 2013

(54) Locally Connected Cloud Storage Device

(71) Applicant: Gary M. Dunham, Fort Valley, VA (US)

(72) Inventor: Gary M. Dunham, Fort Valley, VA (US)

(21) Appl. No.: 12/975,678

(22) Filed: Dec. 22, 2010

Related U.S. Application Data
(60) Provisional application No. 61/289,714, filed on Dec. 23, 2009.

(51) Int. Cl. G06F 17/30

(52) U.S. Cl. CPC G06F 17/30194
USPC 707/827

(57) ABSTRACT

The present invention includes systems and methods for implementing a locally connected cloud storage device. The locally connected cloud storage device includes a data storage medium; one or more network adapters capable of connecting the cloud storage device to a network; a file system; and an operating system. The operating system and file system are capable of providing an end user access to at least one storage cloud having at least one volume for data stored in the data storage medium. The cloud storage device also includes a user interface capable of receiving commands reflecting desired settings for the end user and the volume. The user interface, upon receiving a command reflecting desired settings, interacts with the file system and the operating system to effectuate the desired settings.

### CROSS-REFERENCE TO RELATED APPLICATION

This application claims the benefit of the U.S. Provisional application No. 61/289,714, filed on Dec. 23, 2009, the entirety of which is incorporated herein by reference.

### FIELD OF THE INVENTION

The present invention generally relates to storage systems. More particularly, the present invention relates to a locally connected cloud storage system.

### BACKGROUND OF THE INVENTION

Data storage has traditionally been accomplished through the use of a fixed-capacity hard drive directly connected to a computer motherboard or a microprocessor. As computer networks (e.g., WANs, LANs, etc.) began to proliferate, storage needs increased, which led to the development of “file servers.” A conventional “file server” may be characterized as a machine running computer applications and having data storage space which may be shared and accessed by other computers in the network. While conventional file servers acted as central software sharing and data storage media, computers not physically and directly wired to the file servers had little to no access to the resources provided by those file servers. In addition, as a business' data storage needs grew, file server maintenance became increasingly expensive. As a result, many companies began making large capital investments in centralized information technology (“IT”) systems and facilities.

Updating or upgrading servers to implement a centralized IT system is a slow and costly process. For example, application deployment is a time-consuming process which significantly increases the workload of IT departments, which constantly remain busy with resolving and troubleshooting existing issues, as the IT department must ensure that the application deployment does not cause down time or compatibility issues. In addition, when bandwidth requirements and demand for data grow more rapidly than expected, server resources may be pushed to the limit, which in turn puts business continuity at risk.

With the advent of high speed Internet and broadband connectivity, and an increasingly mobile work-force, businesses need more versatile data storage solutions than that offered by the conventional IT data storage infrastructure. Mobile workers, telecommuters, ad-hoc workgroups and open complementary business partnerships have created the need for data and applications to be made available from anywhere Internet or wireless connectivity can be found. Pursuant to this paradigm shift, companies both small and large began to question their investments in IT. The “software as a service” (“SAAS”) industry grew as an alternative to both the traditional data storage model and the traditional application execution model. The SAAS model allows a company to outsource their IT—access to applications like email, contact management, inventory, accounting software, etc.—and pay third party SAAS providers for only what they use.

The SAAS model offers many benefits to end users. First, the fixed hardware and software costs can be reduced to a more manageable monthly fee, for example, a fee based on the demand for the service being offered. Second, use of the SAAS model allows an employer to provide services to its employees with less technical staff on the pay-roll. Finally, use of the SAAS model reduces the time to deploy an application from months to hours in most cases.

SAAS has also led to the increased virtualization of hardware and storage. For example, in addition to offering SAAS a third party service provider may give its customers access to a data storage “cloud” located in the provider's facilities. Public cloud storage service providers, such as Google or Amazon S3 offer businesses advantages in scalability and off-site maintenance for their data storage needs by granting access to a virtualized datastore via the Internet. However, the public cloud storage services also have several drawbacks. For example, a company's transition to a public cloud storage service can be expensive, and often involves reprogramming the company's application software to interface with service provider's software (for example, by adapting to the application program interfaces (“APIs”) of code being executed by the service provider) in order to allow the remote application to create and/or access data stored on the remote cloud. In addition to the significant time and resources needed to accomplish the reprogramming, the reprogramming is usually service-provider specific. That is, most public cloud storage have their own independent APIs, and the reprogramming necessary to work with one service provider will not work with another service provider, and switching providers usually means reprogramming the company's application software again. As a result companies may become “locked in” to a public cloud storage service provider by the high cost of transition from service provider to service provider. Moreover, companies switching to cloud storage services have had to fully entrust the security of their data to the third-party cloud storage service provider, this creates significant barriers to adoption of the cloud storage model. Furthermore, performance and access to data become dependent on the Internet and the service provider, and service outages and quality of service can be a risk to users of the cloud storage service. Another drawback of existing public cloud storage services is that moving large amounts of data across a public cloud to position the data at the selected service provider can be time consuming. For all these reasons, a company may not only be reticent to adopt a cloud storage model, but may also be “locked in” to the first third-party service provider they choose by the high cost of moving to a different third-party service provider (including reprogramming for a different interface or API, moving the data, dealing with an new provider's performance, etc.).

Therefore, there is a need in the art to address the problems associated with existing storage solutions, in particular with storage solutions related to public cloud storage.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention includes systems and methods for implementing a locally connected cloud storage device (LCCSD). The LCCSD offers businesses a solution that provides the benefits of the cloud storage model and overcomes many limitations of the prior art. The present invention provides a cloud storage architecture that is scalable, and may be preconfigured, tuned and may be quickly deployable to companies to provide cloud storage services to their employees, applications and business partners. The present invention mitigates risks in that it may enable the user of the LCCSD to maintain or ‘cache’ local copies of critical data as backup in case of security breaches or performance problems with the chosen service provider. The LCCSD may be connected to a company's physical network, and may leverage existing corporate telecommunications resources to provide increased performance, security and quality of service. As such, the LCCSD allows for the creation of private cloud storage. In certain embodiments of the invention, access to the private cloud may be provided to end users via the Internet.

The LCCSD may include an operating system, a file system, data storage medium, one or more network adapters and a user interface (“UI”). The data storage medium stores data, for example applications and other software, that may be provided and distributed via the cloud. The one or more network adapters, file system and the operating system may be used to manage and control the data storage medium, requests to access or store data, and the sharing of data through the cloud. The user interface may be implemented as a graphical user interface (“GUI”) to allow for set up and management of the cloud and control of access to the data on the cloud. The user interface may interact with the operating system, the file system and the one or more network adapters, and may facilitate the management of settings and options to allow the cloud to be configured as needed. Through the combination of these elements, the LCCSD may be configured to provide end-users with transparent access to the data stored on the cloud. Regardless of the computer or operating system used locally by the end-user, the LCCSD of the present invention allows the end user to access the user data as if it were stored in the end user's native environment (e.g. Microsoft Windows, Mac OS, Linux, Unix, etc.).

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

The invention will be further understood, by way of example, with reference to the accompanying drawings, in which:

FIG. 1 illustrates an exemplary computing device for implementing a server on which the locally connected cloud storage device software may be implemented.

FIG. 2 illustrates the basic components of an locally connected cloud storage device in accordance with one embodiment of the present invention.

FIG. 3 illustrates a locally connected cloud storage device connected to a network in accordance with one embodiment of the present invention.

FIG. 4 illustrates a locally connected cloud storage device that maintains multiple storage clouds connected to a network in accordance with one embodiment of the present invention.

FIG. 5 illustrates a locally connected cloud storage device connected to a network that is configured to allow both in-network and out-of-network end users access to its storage cloud via the Internet, in accordance with one embodiment of the present invention.

FIG. 6 illustrates a locally connected cloud storage device connected to a network that is configured to allow both in-network and out-of-network end users access to its storage cloud via the Internet, and is further configured to interface with at least one third party public cloud storage service on the Internet in accordance with one embodiment of the present invention.

FIG. 7 illustrates an example of a network with multiple locally connected cloud storage devices which maintain multiple storage clouds, allow both in-network and out-of-network end users, and interface with at least one third party public cloud storage service on the Internet in accordance with one embodiment of the present invention.

### DETAILED DESCRIPTION OF ILLUSTRATIVE EMBODIMENTS OF THE INVENTION

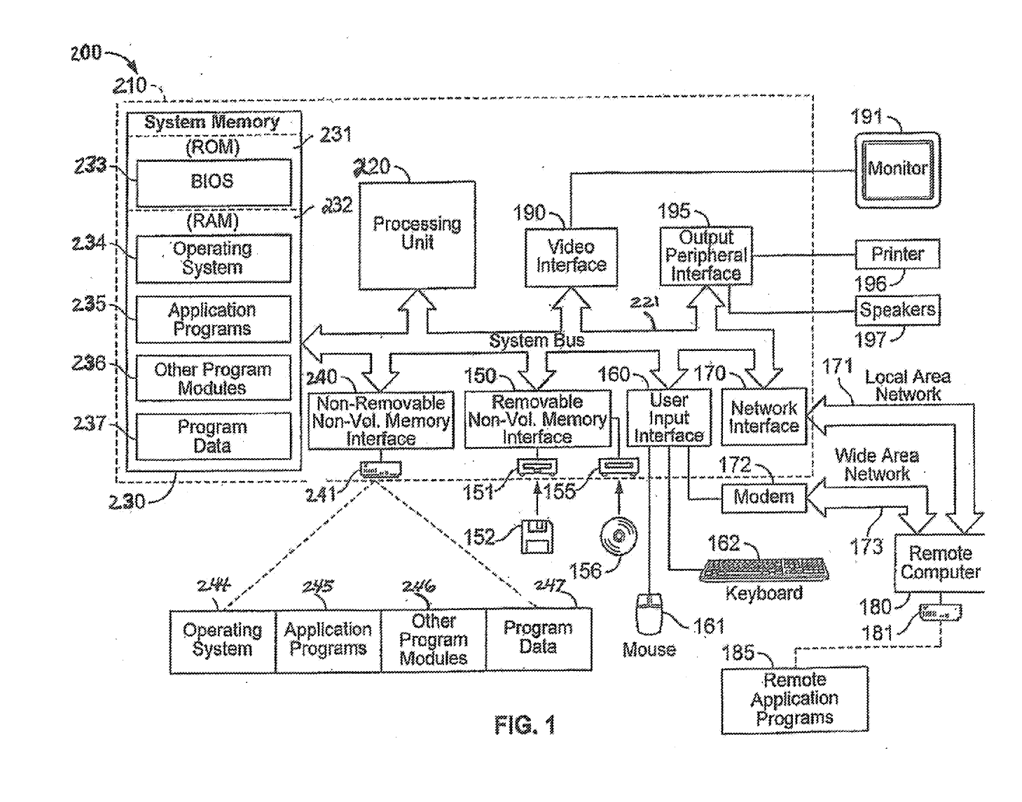

The present invention may be implemented in one or more servers, one or more client terminals, including computer terminals, or a combination thereof. An exemplary computing device for implementing a server is illustrated in FIG. 1. For example, the computing environment illustrated in FIG. 1 may be used to implement a database server, an email server, a DNS server, a POP/IMAP server, a digital fulfillment server, a media server, a local server, a global server, a file server, etc.

FIG. 1 illustrates an example of a suitable computing system environment 200 on which features of the invention may be implemented. The computing system environment 200 is only one example of a suitable computing environment and is not intended to suggest any limitation as to the scope of use or functionality of the invention. Neither should the computing environment 200 be interpreted as having any requirement relating to any one or combination of components illustrated in the exemplary operating environment 200.

The invention is operational with numerous other computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by one or more computing devices.

Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system that may be used for implementing the invention includes a computing device 210 which may be used for implementing a server. Components of computing device 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that may be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 1 illustrates operating system 234, application programs 235, other program modules 236, and program data 237.

The computing device 210 may also include other removable/non-removable, volatile/nonvolatile computer storage media. By way of example only, FIG. 1 illustrates a hard disk drive 240 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 210. In FIG. 1, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 220 through a user input interface 160 that is coupled to the system bus, but may be connected by other interface and bus structures, such as a parallel port, game port or a universal serial bus (USB). A monitor 191 or other type of display device may also be connected to the system bus 221 via an interface, such as a video interface 190. In addition to the monitor, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The LCCSD may be defined as a device that may directly connect to a network (e.g., WAN, LAN, etc.), and may provide users that are on, or that connect to that network with access to one or more “private” storage clouds, that are maintained on the LCCSD, in whole or in part. Optionally, several LCCSDs may be connected to the same network, and may maintain and provide users access to either separate storage clouds kept on each LCCSD, storage clouds that are formed and kept across several LCCSDs, or any combination thereof. The LCCSD shares many of the benefits of the traditional file server, as may be kept and controlled on a company's network, but also provides the company with the benefits of the cloud storage model. Unlike a traditional file server, which grants users access to specific locations on a volume of a hard drive, the LCCSD provides a layer of abstraction—one or more storage clouds. The LCCSD provides users access to data storage space on a volume within a storage cloud, which can span multiple hard drives, other data storage media, other LCCSDs, and may even interface with third-party public storage clouds. In this fashion, the LCCSD(s) allow the storage cloud to be scalable and expandable, while changes to the storage cloud remain invisible to the end user.

LCCSD(s) may also optionally be configured to interface with third-party “public” cloud storage service providers, for example being configured to exchange data through third-party service providers' respective APIs. In such embodiments, LCCSD(s) may provide “hybrid” cloud storage, with integrating aspects of the “private” clouds on the LCCSD(s) and the third-party “public” clouds. The LCCSD(s) may allow the system administrator to control the maintenance of and access to data on both the LCCSD clouds, and on the public clouds. In this manner LCCSD(s) may be used as a stepping stone solution to transition a company from a traditional file server to a cloud storage model, while maintaining many of the security and control benefits of the file server model. The LCCSD(s) may also solve the problem of third-party service provider lock-in, because the LCCSD(s) may be pre-configured to interface with the software (e.g., API's) of a variety of third party providers, thus reducing transition cost and enabling a company that uses such a LCCSD to utilize more than one third-party service provider.

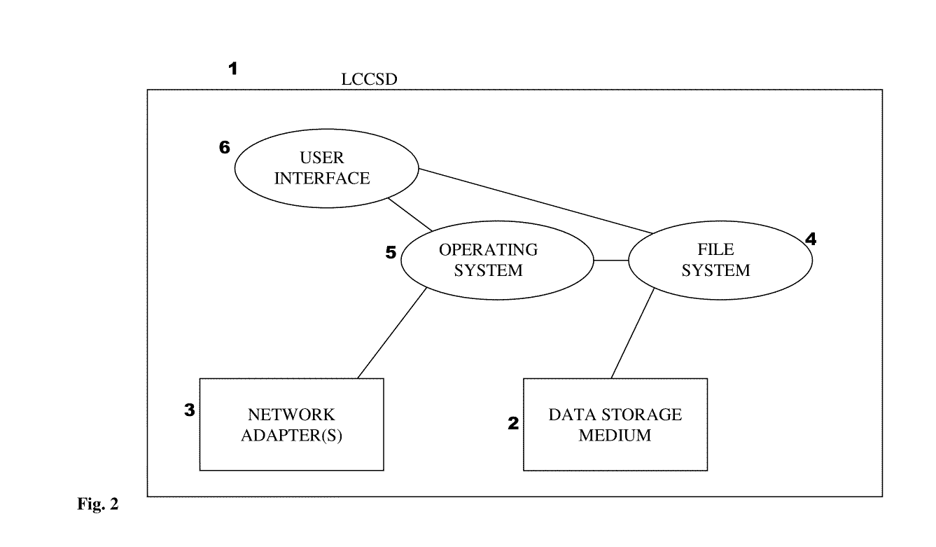

FIG. 2 illustrates basic elements of a LCCSD 1, which may include a data storage medium 2, one or more network adapters 3, a file system 4, an operating system 5, and a user interface 6. One of ordinary skill in the art will recognize that other devices can be used in connection with the LCCSD 1, such as input devices (mouse, keyboard, touch screens, scanners, biometric readers, etc.), output devices (monitors, printers, etc.), caches, random access memory, CPUs, GPUs, cooling systems, etc. These components are discussed in limited fashion, or not at all because they are not central to the invention described herein, and because one of ordinary skill in the art would understand that these components may be used with the LCCSD 1.

The LCCSD 1 includes a physical layer and a software layer. The physical layer may include the data storage medium 2 and one or more network adapters 3. It may also include any number of other components commonly used by computers and servers, such as CPUs, RAMs, a cooling system, input/output ports, etc.

The software layer may include the file system 4, the operating system 5 and the user interface 6. It may also include other applications and programs common to computer and servers.

The data storage medium 2 houses the data to be shared in the cloud. The invention may be practiced with any data storage medium 2 capable of storing electronic data. In some embodiments of the present invention, the data storage medium 2 may be a hard drive or an array of hard drives. The hard drive or other storage medium may be connected to other elements of the LCCSD 1 by any means currently known in the art for communication such devices, including commonly used controllers, such as RAID, SAS/SATA, SCSI, IDE, etc., or through other input/output ports, such as USB, fiber optic channels, etc. Additionally the data storage medium 2 may be provided with an extender to allow for expansion, for example, a connection to additional hard drive arrays. In certain embodiments of the present invention, the data storage medium 2 may include a back up system, such as a redundant hard drive array, or any other back up means known in the art. For example, in one embodiment of the present invention an LCCSD 1 may include as a data storage medium 2 a computer, server or hard drive array with multiple bays or slots for connecting hard drives, such as enterprise class hard drives, which is also expandable to connect to other hard drives or hard drive arrays through an extender such as a daisy chain connection, switch, or other means of connection known in the art.

The one or more network adapters 3 may connect the LCCSD 1 to a company's network, the Internet, routers, firewalls, end user computers/devices, other LCCSDs, etc. The network adapter(s) 3 may accomplish this through hard line or wireless connections. The types of network adapters 3 that may be used include, without limitation, various types of Ethernet, fiber optic, and wireless adapters.

The file system 4 may manage and control the usage of the data storage medium 2. The invention may be practiced with any file system 4 currently known in the art or in development, such as the Zettabyte File System (“ZFS”), Network File System (“NFS”), Parallel Network File System (“PNFS”), New Technologies File System (“NTFS”), etc. Use of the file system 4 in the present invention may offer efficiency, scalability, and enhanced performance in both speed of data access and reliability. In some embodiments of the present invention, the LCCSD's 1 file system 4 offers infinite size (i.e., the file system is designed such that there is no limitation on the size of the storage space that it is capable of managing) and name space, and is optionally configurable to automatically address data back up.

The LCCSD's 1 operating system 5 communicates with and supports the physical layer and the file system 3, and provides the user interface 6 and other components of the software layer access to the components of the physical layer, enabling interaction between the software layer and the physical layer.

The invention can be practiced with any of the operating systems 5 known in the art, such as Open Solaris, Unix, Linux, Windows, Mac OS, etc. The operating system 5 preferably allows flexible configuration of connectivity, speed, software execution rate (e.g., rate at which the operating system can run non-operating system software), scalability and security. The operating system 5, together with the one or more network adapters 3 and the filing system 4, receive and handle data requests and also execute commands and setting changes from the user interface 6.

In the present invention, data access may be handled through a wide variety of protocols, according to the system administrator's preference. These protocols may include, without limitation, any set of the Common Internet File System (“CIFS”), NFS, Internet Small Computer System Interface (“iSCSI”), Fibre Channel (“FC”), Advance Technology Attachment (“ATA”) over Ethernet (“AOE”), Web-based Distributed Authoring and Versioning (“WEBDAV”) and RSYNC. One of ordinary skill in the art would recognize that any other existing or newly developed data access protocol can also be incorporated into the practice of the invention.

In one embodiment of the invention, the LCCSD provides the end user access to a folder or file in the same manner in which he or she would access a locally-kept folder or file. The LCCSD 1 interprets the user's request, checks the appropriate permissions, and, if appropriate, provides the requested data.

The user interface 6 may be designed to allow the system administrator(s) an intuitive approach to configuring the LCCSD 1. The user interface 6 may be implemented as a graphical user interface, though one of ordinary skill in the art will recognize that the user interface 6 and any feature thereof can also be embodied as a non-graphical interface. For simplicity, only the graphical user interface will be described herein. The graphical user interface may be accessed locally, may be accessed remotely, or both.

The user interface 6 may include a set of authorized administrators with varying degrees of security levels and permissions to adjust the commands and settings that each administrator is authorized to run or change. The user interface 6 may have a security measure to require administrator identification, including, without limitation one or more of the following: user names, passwords, biometric readings, access keys, etc.

The user interface 6 may include a status reporting feature. This feature may give graphical readouts of system statistics, including the LCCSD's 1 current or historical CPU utilization, network bandwidth usage, data storage medium bandwidth usage, data request frequency and types, total data space, free data space, version information, and other general statistics. Additionally, the status reporting feature may give the status and performance reports of individual data volumes (physical or virtual), network services, replication progress, and fault or error reports. The status reporting feature may further contain a profile manager, which may organize and maintain statistical information, such as TCP/IP MIB statistics (for example, data on TCP bytes sent, received, received in duplicate, retransmitted, or received out of order), virtual memory statistics; storage input/output patterns; statistics on the interrupts aggregated by CPU; statistics measuring the aggregated CPU utilization, and input/output throughput statistics as measured by the file system 4 of the LCCSD 1 (such as by the ZFS SPA sync function). A person of ordinary skill in the art will appreciate that the listed types of statistics are exemplary, and that many other statistcal measure and analytic scripts could be used in connection with the invention. The status reporting feature may further contain a timer setting to determine the frequency with which certain statistics and analytics programs are run or refreshed. The status reporting feature may further indicate the method in which certain statistics are kept, such as whether they are aggregated or measured at discrete intervals. The status reporting feature may further have an analytics tool which further collects, analyzes, and reports on aspects of the statistical data and logs. The status reporting feature may further track and provide information about end users' access to data, including the timing and frequency of their data access, the types of data access (reading, writing, modifying, etc.) and the status of the end users' computer or other device from which the end user accessed the data (portable computing devices, smart phones, specialized equipment, etc.). Additionally, where multiple LCCSDs are in use, the status reporting feature may list the status of other LCCSDs, or provide links to the other LCCSDs. Additionally LCCSDs may be put into groups, and may show group statistics, and/or provide links to other LCCSD groups. Additionally, the user interface 6 may accommodate dynamic tracing technologies for system troubleshooting.

The user interface 6 may include a settings manager, allowing administrators to manage the settings and preferences on the LCCSD 1, including basic settings, users, network settings, data storage medium 2, SMTP settings, system restoration checkpoints, and other preferences. The LCCSD's editable basic settings may include a host name, domain name, administrative password, plugins, SSH/SSL settings, etc. User settings may include user name, user group, password/security metrics, system permissions, email address, description, etc. Network settings may include IP address, MTU size, gateways, wireless access settings, LDAP settings, etc. The data storage medium 2 settings may include summaries and information on both the physical mediums, the virtual mediums/disks etc. The physical medium settings may include the type of medium, driver, size, etc. The virtual medium settings may include size, volume name, description, address into the data storage medium 2, protocol access permissions, etc. The SMTP settings, if applicable, may include a server name, and password, a username to send reports from, and a list of email addresses to where reports should be sent, etc. The system restoration checkpoint settings may allow for management of checkpoints, and information on when they were made, and how often they should be made, etc.

The user interface 6 may include a data management system that provides summaries for and facilitates the organization of day to day data management operations. Such operations may include volume management, folder management, service management and statistic/error report management. The summary information may include a list of volumes (blocks of data within the data storage medium), which may include a description of the volumes' configuration including any redundancy settings, the size of the volume, the amount which is used and the amount that is available, its percentage capacity, its status (such as whether it is online or not), and may optionally allow for the modification of the volume directly, such as increasing the size, deleting the volume, or exporting the volume. Additionally summary information may be provided for the individual disks or other media which make up the data storage medium, and general information may be shown as to their size, activity, settings and/or performance. Folder summary information may include the location and name of the folder or directory, the folder's size, amount and or percentage used and/or available, the protocols that are enabled for the folder (for example, CIFS, NFS, FTP, RSYNC WebDAV, etc.), an option to have an index kept for the folder, and an option to modify the folder settings or delete the folder. The data management system may further have a method to filter or search for specific folders or volumes. The volume and folder management settings may include: configuration settings, such as permissions, redundancy settings or groupings, etc.; size management tools; import, export and duplication tools; snapshot tools for backing up the volume or folder; and volume and folder creation tools, including naming, copy/redundancy settings; size and user/group access permissions; protocol permissions; etc. The volume and folder creation tools may allow for the creation of volumes and folders, and include several settings to aid in the creation and configuration of the volume or folder, such as options to pick a disk or other portion of the data storage medium 2 or a volume where the respective volume or folder would be housed, a name for the volume or folder, a description, a size for the volume or folder, an option to set the block size for files in the volume or folder, an option for compressing the volume or folder and selecting a compression algorithm, the number of copies of the data in the volume or folder to be kept, and options for whether file and folder names in the volume or folder should be case sensitive. The data management system may further provide a folder or volume editing tool, which provides certain basic information about the folder or volume, such as its name, date of creation, amount of used space, amount of free space, a compression ratio, its location or mountpoint within the data storage medium 2 or in the file system 3, whether it is case sensitive, etc. The volume or folder editing tool may further allow for the editing of which end users are allowed to access the volume or folder and the types of permissions that each such end user is given, such as permission to read, write and modify data, modify, add or delete folders, execute applications, etc. The snapshot tools may include features to allow the creation (or deletion) of dated copies of the state of a folder or volume, which can be used for folder and volume backup, cloning or rollback. Additionally the snapshot tools may be configurable to work recursively, creating snapshots for all child-folders of a folder. The data management system may also provide summary information for snapshots, including the name of the volume or folder of the snapshot, the date of creation, the associated service, the size of the volume or folder of the snapshot, the size of the used portion of the volume or folder of the snapshot, and the option to rollback, clone or delete the snap shot. Data management services (e.g., runners) may include memory checks, file system checks, network checks, utilization checks, synchronization services, scrubbing services, automated tiering, backup and snapshot services, protocol services, etc. The services or runners may be configured to activate on certain events, or may be scheduled to run at predefined intervals or times. The user interface 6 may include a services or runners tool which shows all services or runners currently active on the LCCSD 1, including a description of the type of service or runner (whether it is a fault-triggered service, a reporter, a statistics collector, etc), its status (enabled, disabled, or other), its state (ready, running, idle or other), and its schedule. The user interface 6 may be further provided with tools to create services or runners and control when they are run, and the parameters with which they run, including scrubbing services, snapshot services, tiering services and synchronization services, particularly when volumes or folders are utilizing the redundancy options. Additionally, the data management system may allow protocol server setting management, such as FTP, CIFS, NDMP, NFS, RSYNC, WEBDAV, etc. Also the data management system may maintain logs recording services, statistics and error reporting. It is understood by a person of ordinary skill in the art that the options, services and settings listed are exemplary of the types of options, services and settings that might be used in a data management system, and are not limiting. An embodiment of the user interface 6 of the invention need not contain all of these options, services and settings, and indeed may contain additional options, services and settings depending on the needs of an individual system.

The user interface 6 may include a virtual machine management center allowing the use and management of virtual hosting, virtual storage, and other virtual machine tools. This organization of functionality for the user interface is merely meant to be exemplary. A person of ordinary skill in the art will recognize that the user interface can be organized in a multitude of different ways, and that the invention can be practiced with just a subset of the above described functionality.

The LCCSD 1 itself is capable of creating and managing a data cloud for a network. The LCCSD 1 may be designed to be invisible to the end user. The end users may be anyone connected either locally or remotely, given permission to access the data cloud, including employees, contract workers, business partners, etc. End users may access the data stored in the parts of the storage cloud they have permission to access as if they were accessing a drive on their local machine. In some embodiments of the invention, multiple LCCSDs may be located on the same network. In such embodiments, each LCCSD 1 may maintain separate cloud(s), they may be integrated to form one unified cloud, or any desired combination(s) thereof. In some embodiments of the present invention, one or more of the LCCSDs may be configured to maintain complete data sets of the data stored in each LCCSD 1on the network. In an exemplary embodiment, a company may put LCCSDs in each branch office, forming data storage clouds grouped by department, and have a larger scale LCCSD 1 at the central office that maintains a complete data set of each departmental cloud. In such a configuration, the branch office LCCSDs may routinely communicate with the central office LCCSD 1 to keep its data set current.

In some embodiments additional LCCSDs may be connected via the company's network. In such embodiments the multiple LCCSDs may be configured to communicate in order to provide a cloud storage space accessible to all end users. In some embodiments, one or more of the LCCSD's 1 may be configured to maintain a complete and updated data set, to offer full data redundancy regardless of outages of any one (or more) LCCSD 1.

In other embodiments, the LCCSD 1 may be configured to interface with one or more public cloud storage services. As a part of this, the LCCSD 1 may be provided with tools to convert the cloud(s) maintained on the LCCSD 1 so that they can be uploaded and synchronized with the public cloud storage service. The public cloud storage service may maintain a complete data set of all data kept in all the LCCSDs on the network. In other embodiments, both the public cloud storage service and one or more of the LCCSDs on the network maintain complete data sets. In yet another embodiment, a complete data set is maintained on LCCSDs on the network, and incomplete data sets are kept on one or more public cloud storage services. In this manner, no single public cloud storage service has access to a complete data set, minimizing the security risk. Also, by using multiple public cloud storage services, together with an LCCSD 1 or multiple LCCSDs, the company making use of the cloud data storage can maintain a complete data set on site and off site, while preventing any one public cloud storage service from having a complete data set. This prevents a company from getting locked in to a public cloud storage service, and allows the company to switch public cloud storage providers with minimal cost if the company becomes dissatisfied with a provider's service or performance.

Public cloud storage services may be used to combine and synchronize LCCSDs clouds located on separate networks. Private clouds are hardware and software solutions which emulate public cloud offerings but are generally housed, controlled or maintained on-site by a company. Private clouds may be hybridized by extending those the feature of the private cloud across the Internet allowing access to select end users, (e.g. telecommuters, mobile employees, single person branch offices, select authenticated business partners, etc.).

Hybrid clouds are created by combining all of the native features of a private cloud with a public cloud storage service, and in essence treat the data storage capabilities of that private cloud as a front end, or staging point for moving data into the public cloud where storage resources are more sizeable and require less capital investment. A hybrid cloud configuration offers a company many advantages. First, it allows for full and easy backup of all or selected data sets kept in the private cloud to the remote, less costly storage facilities of the third-party public cloud service providers. Second, it addresses the problem of application latency which crops up if a public cloud storage service is storing live applications. Application latency occurs because moving data sets across the Internet to a third-party public cloud storage service provider takes longer than writing it to a locally resident disk storage media. In some embodiments, an LCCSD can be configured to allow end users to write and read the data locally and transparently in the background, while the LCCSD replicate that data to a third-party cloud storage service provider, or to another remotely located LCCSD. By allowing the user to read and write locally, the LCCSD avoids the application latency problem, and by replicating the data to the third party cloud storage service provider, the benefits of using a public cloud storage service are preserved. Third, by keeping either all relevant data or at least the most frequently, important or company sensitive data on both locally on the private cloud and on the third party cloud storage service provider's public cloud, a hybrid cloud serves as an effective disaster recovery storage solution. If disaster strikes locally the data is still available and can be retrieved from the public cloud. On the other hand, if the public cloud system fails or becomes unavailable, the data the local data is kept up-to-date and remains available until the public cloud system becomes available, is repaired or another third-party cloud storage service provider is selected. The advantages presented by the redundancy, efficiency and consistency of a hybrid storage cloud is of particular value to companies concerned with meeting the Sarbanes Oxley requirements.

In yet another embodiment of a hybrid cloud integrates the LCCSD' s private cloud with multiple third-party public cloud storage service providers so that no single third-party public cloud storage service provider has a complete set of a company's data. By using known encryption technologies and managing the manner in which the data is distributed amongst the selected third-party public cloud storage service providers, a company can guard its interest in the event that a third-party public cloud storage service provider's security is compromised and unauthorized individuals gain access to the remotely stored data. To achieve these benefits absent the use of a LCCSD configured to interface with multiple third-party cloud storage service provider, a company would have to maintain a file server and an IT staff, staff additional programmers to go through the costly process of integrating and changing the company's applications to work with and run on the various third-party public cloud storage services, and actively coordinate the distribution of data amongst the multiple third-party public cloud storage services. These examples of the uses and advantages of hybrid storage clouds are meant to be illustrative, and not limiting. A person of ordinary skill in the art would recognize that a multitude of other combinations and manners in which the invention may be practiced.

Additionally, in certain such hybrid storage cloud embodiments, the LCCSD may be configured to interface with public cloud storage service providersby interfacing with and interact with the public cloud storage service provider's software (e.g., through APIs), and to manage the interaction between the private cloud(s) and the public cloud. For example the LCCSD 1 may be configured to maintain a complete and updated data set in the private cloud and/or in the public cloud to provide full redundancy. One of the main advantages of such embodiments is that a company can use the LCCSD 1 as a stepping stone from the traditional file server model to the public cloud storage service model. A company may be outgrowing the traditional file server model, but may not be ready to expend the time and resources to go to a public cloud storage service. The LCCSD 1 offers such companies a gap filling solution, that they can switch to and later use to integrate with a public cloud storage service.

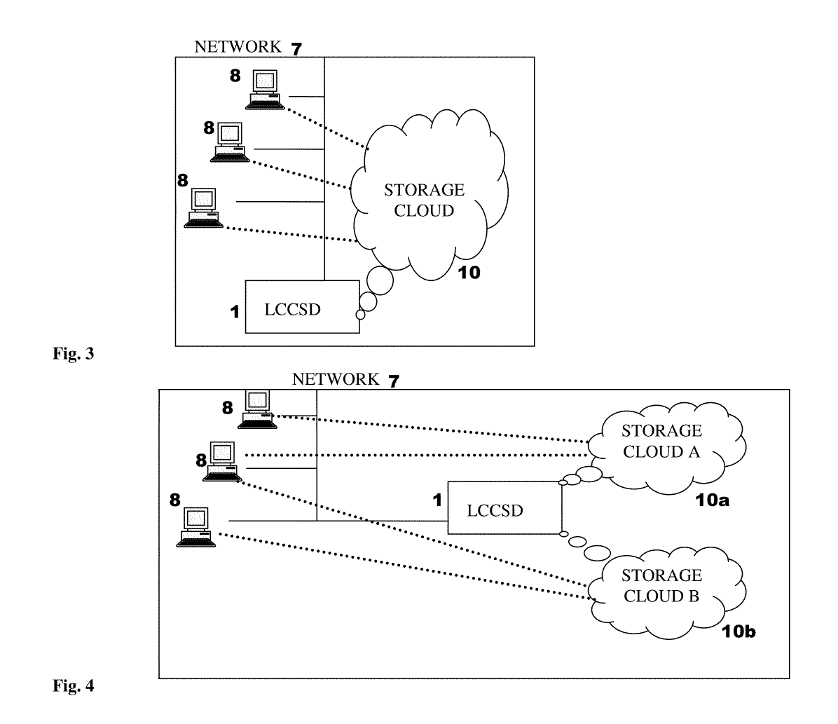

FIGS. 3-7 provide several illustrative embodiments of the invention as examples of the variety of configurations and possible uses for an LCCSD 1.

FIG. 3 illustrates an LCCSD 1 which maintains a storage cloud 10, that is connected to a network 7 having several in-network end users 8.

The in-network end users may be defined as end users who have direct access to the network, whether by hardwire connection (as shown in FIG. 3) or wireless connection. The storage cloud 10 may be defined as an abstraction maintained by the LCCSD 1, which provides the end-users access to data storage space controlled by the LCCSD 1 as described above.

As shown in FIG. 3, the LCCSD 1 is configured to provide the in-network end users 8 access to the data kept in its storage cloud 10. As described above, multiple LCCSDs may be added to the network 7 depicted in FIG. 3, which will then interact with each other, and may be configured to maintain a storage cloud 10 in several ways, including: each LCCSD 1 maintains a unique portion of the storage cloud 10, each LCCSD 1 maintains a complete copy of the storage cloud 10; or each LCCSD 1 maintains a portion of the storage cloud 10 which may partially overlap with the portions held by other LCCSDs on the network so that there is redundancy to some or all of the storage cloud across the LCCSDs. It would be understood by a person of ordinary skill in the art that a multiple LCCSD configuration may be practiced in each of the embodiments described in FIGS. 4-7 as well.

FIG. 4 illustrates an LCCSD 1 which maintains two storage clouds 10a and 10b, that are connected to a network 7 having several in-network end users 8.

Storage cloud A 10a and storage cloud B 10 b may be implemented as separate data storage spaces maintained by the LCCSD 1, though within the LCCSD 1 they may or may not be kept on the same physical storage medium. The storage cloud A 10a and storage cloud B 10b are separate in that they may have different sets of authorized end users, or different business purposes or uses. For example a company might set up separate clouds for employees, corporate management, and third-party partners, where some end users may have access to only one cloud and others may have access to all three.

As depicted in FIG. 4, the LCCSD 1 provides in-network end-users 8 access to the data kept in its storage clouds 10a-b. Depending on the permissions of the end user, an end user may be provided access to only storage cloud A 10a, only storage cloud B 10b or both storage cloud A 10a and storage cloud B 10b. One of ordinary skill in the art would understand that more than two storage clouds may be maintained by an LCCSD 1, and similar to the multiple LCCSD configuration option described above in connection with FIG. 3, multiple LCCSDs may be used in connection with the embodiment illustrated in FIG. 4. When adding multiple LCCSDs to the system illustrated in FIG. 4, each LCCSD 1 may maintain all or part of a single storage cloud, or all or part of multiple storage clouds, with or without redundancy.

FIG. 5 illustrates an LCCSD 1 which maintains two storage clouds 10a and 10b, that is connected to a network 7 having several in-network end users 8, and where the network 7 is connected to the Internet 11, and several out-of-network end users 9 are also connected to the Internet 11.

An out-of-network end user 9 may be defined an end user that is not connected directly to the network 7, but rather accesses the network 7 via an intermediary connection, such as through the Internet 11.

As shown in FIG. 5, the LCCSD 1 may be defined configured to provide the in-network end users 8 access to the data kept in its storage cloud 10. Additionally, the LCCSD 1 may be connected to the Internet either directly or through the network, and also provides out-of-network end users 9 access to the data kept in its storage cloud 10 via the Internet 11. One of ordinary skill in the art would understand that like the embodiments illustrated in FIGS. 3 and 4, the embodiment illustrated in FIG. 5 may also be implemented with multiple LCCSDs on the network, with multiple storage clouds, or both, and out of network end-users may be provided access to any additional storage clouds via the Internet as well.

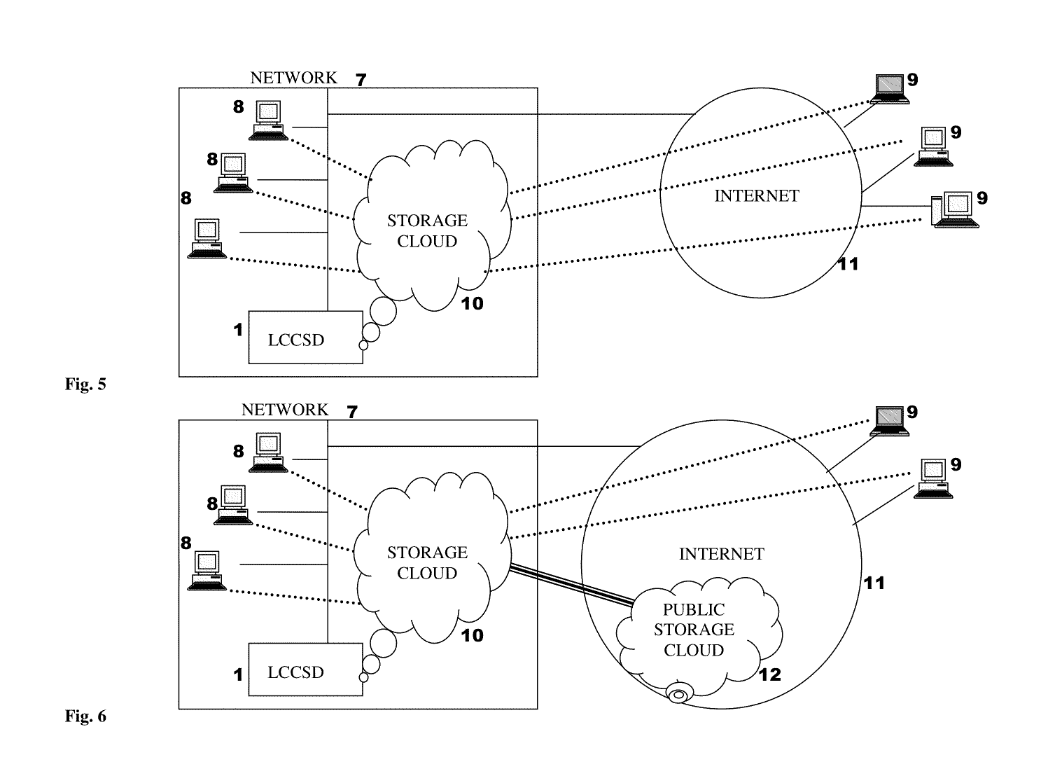

FIG. 6 illustrates an LCCSD 1 which maintains a storage cloud 10, that is connected to a network 7 having several in-network end users 8, and where the network 7 is connected to the Internet 11, several out-of-network end users 9 are also connected to the Internet 11, and where the LCCSD 1 interfaces with public storage cloud 12 on the Internet 11.

As described above, the public storage cloud 12 may be defined as a data storage service provided by a third-party cloud storage service provider via the Internet 11 where a company may store data on off-site storage space.

In addition to the features depicted in FIG. 5, the embodiment in FIG. 6 depicts an LCCSD 1 that can interface with a public storage cloud 12 maintained by a third party public cloud storage service provider. As described above, the relationship between the LCCSD's 1 storage cloud 10 and the public storage cloud 12 (represented in FIG. 6 by a triple line) can vary according to a company's needs. The public storage cloud 12 may be used to house a complete copy of the LCCSD's 1 storage cloud 10 for redundancy. Alternatively, the LCCSD 1 may be configured to use the public storage cloud 12 as an extension of its own storage cloud 10. Yet another alternative is to use the public storage cloud 12 to store part, but not all of the LCCSD's 1 storage cloud 10. It would be understood by one of ordinary skill in the art, that like the illustrative embodiments already described above, the embodiment in FIG. 6 may be further modified to contain multiple LCCSDs, and/or to keep multiple storage clouds, some or all of which may be interfaced with the public storage cloud 12. Additionally, the embodiment depicted in FIG. 6 may be configured to interface with more than one third-party public storage service providers' public storage cloud 12.

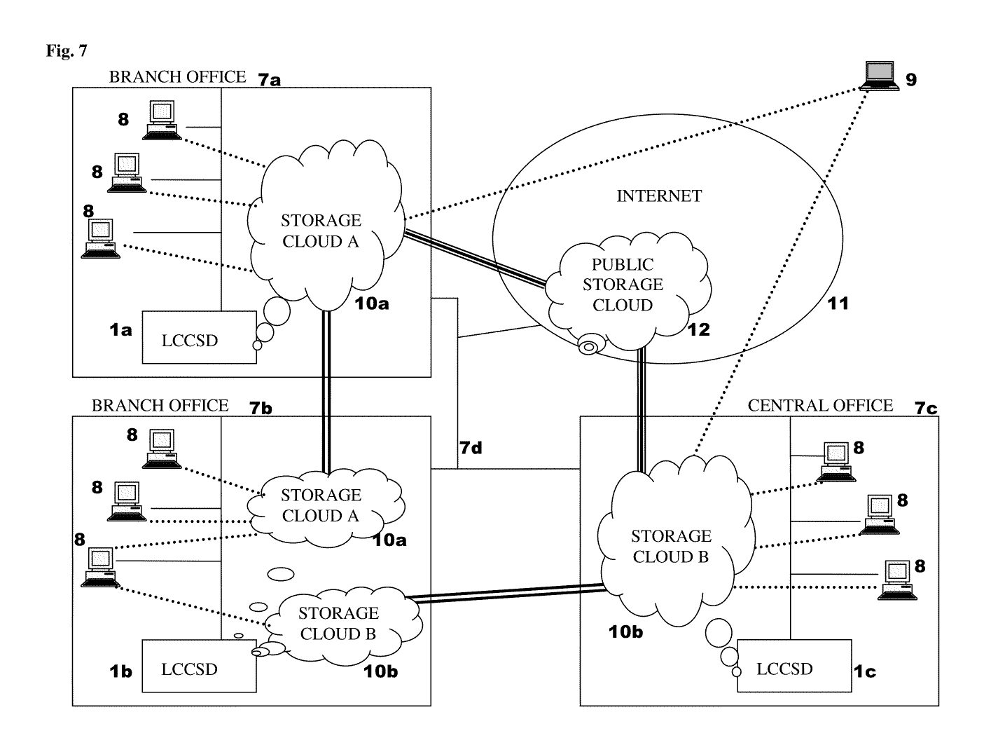

FIG. 7 illustrates an exemplary embodiment of the invention which combines at least some of the features described in relation to FIGS. 3-6. FIG. 7 depicts a network that includes three subnetworks, branch office 7a, branch office 7b and central office 7c that are connected by hard lines 7d. The figure also illustrates several in-network end users 8. The network is connected to the Internet 12, where out-of-network users 9 also connect. Three LCCSDs 1a-c may connect to the network, and collectively, they may maintain two storage clouds 10a and 10b. Both of these storage clouds may interface with a public storage cloud 12.

The three LCCSDs depicted in FIG. 7 may be connected to each of the subnetworks 7a-c, respectively. Collectively they may maintain two storage clouds 10a and 10b, where storage cloud A 10a is maintained by LCCSDs 1a and 1b, and storage cloud B is maintained by LCCSDs 1b and 1c. The double lines between LCCSD 1a's storage cloud A 10a and LCCSD 1b's storage cloud A 10a, and between 1b's storage cloud B 10b and LCCSD 1c's storage cloud B 10b represent the integration or link between the portions of the storage clouds maintained on each respective LCCSD. As explained above, this integration may be made in several ways, including maintaining complete copies of the storage cloud on each LCCSD for complete redundancy, maintaining unique portions of each storage cloud on each LCCSD for no redundancy, or an configuration which gives partial redundancy. Both in-network end users 8 and out-of-network end users 9 may be granted access to either or both storage clouds 10a and 10b by the LCCSDs 1a-c. FIG. 7 also shows that the LCCSDs la-c interface both storage clouds 10a and 10b interface with a public storage cloud 12 maintained by a third-party public cloud storage service provider. As described above the interface between the LCCSDs' storage clouds 10a and 10b and the public storage cloud may be configured to store some, all or none of the data kept on the LCCSDs storage clouds 10a and 10b on the public storage cloud. One of skill in the art will recognize that additional LCCSDs and more storage clouds may be added to the embodiment depicted in FIG. 7.

The foregoing description of possible implementations consistent with the present invention does not represent a comprehensive list of all such implementations or all variations of the implementations described. The description of only some implementation should not be construed as an intent to exclude other implementations. Artisans will understand how to implement the invention in many other ways, using equivalents and alternatives that do not depart from the scope of the following claims. Moreover, unless indicated to the contrary in the preceding description, none of the components described in the implementations are essential to the invention.

What is claimed is:

1. A locally connected cloud storage device comprising:
a data storage medium;
one or more network adapters, wherein the one or more network adapters are capable of connecting the cloud storage device to a network;
a file system;
an operating system, wherein the operating system and file system are capable of providing an end user access to at least one storage cloud having at least one volume for data stored in the data storage medium; and
a user interface capable of receiving commands reflecting desired settings for the end user and the volume, wherein the user interface, upon receiving a command reflecting desired settings, interacts with the file system and the operating system to effectuate the desired settings.

2. The locally connected cloud storage device of claim 1 wherein the data storage medium comprises one or more arrays of hard drives.

3. The locally connected cloud storage device of claim 2, wherein at least one of the one or more arrays of hard drives is expandable.

4. The locally connected cloud storage device of claim 1 wherein the data storage medium comprises an extender.

5. The locally connected cloud storage device of claim 1, further comprising a backup system for the file system or the data storage medium.

6. The locally connected cloud storage device of claim 1 wherein the file system is capable of managing a data storage medium of infinite size.

7. The locally connected cloud storage device of claim 1, wherein the locally connected cloud storage device is configurable to allow out-of-network end users access to the volume for data stored in the data storage medium.

8. The locally connected cloud storage device of claim 7 wherein the volume for data stored in the data storage medium is accessible via the Internet by the out-of-network end users.

9. The locally connected cloud storage device of claim 1 wherein the user interface, file system and operating system can provide the end users access to the volume for data stored in the data storage medium is provided to the end users so as to be appear to be accessed through the end user's native environment.

10. The locally connected cloud storage device of claim 1 wherein the user interface is a graphical user interface.

11. The locally connected cloud storage device of claim 1 further comprising an interface for at least one third-party public cloud storage service provider.

12. The locally connected cloud storage device of claim 11 wherein the device is configured to exchange data with a third-party public cloud storage service provider system through an application program interface.

13. The locally connected cloud storage device of claim 1 further comprising an interface for more than one third-party public cloud storage services provider.

14. The locally connected cloud storage device of claim 1 wherein in the system is capable of communicating with at least one other locally connected cloud storage system and providing access to end users to a volume for data stored on a data storage medium of the at least one other locally connected cloud storage system.

15. The locally connected cloud storage device of claim 14 wherein the user interface is capable of accepting commands for managing the settings of the file system, operating system or user interface of the at least one other locally connected cloud storage system.

16. The locally connected cloud storage device of claim 1 wherein the user interface is capable of providing analytical, statistical or performance information relating to the data storage medium, the file system or the operating system.

17. The locally connected cloud storage deviceof claim 14 wherein the user interface is capable of providing analytical, statistical and performance information relating to the data storage medium, the file system or the operating system of the at least one other locally connected cloud storage device.

18. The locally connected cloud storage device of claim 1 further characterized in that the at least one storage cloud comprises two or more storage clouds maintained by the locally connected cloud storage device, and each such storage cloud has a set of end users.

19. A locally connected cloud storage device comprising:
a data storage medium;
one or more network adapters, wherein the one or more network adapters are capable of connecting the cloud storage device to a network; wherein the one or more network adapters are further capable of connecting to the Internet;
a file system;
an operating system, wherein the operating system and file system are capable of providing an end user access to at least one storage cloud having at least one volume for data stored in the data storage medium; and
a user interface capable of receiving commands reflecting desired settings for the end user and the volume, wherein the user interface, upon receiving a command reflecting desired settings, interacts with the file system and the operating system to effectuate the desired settings; and
a public cloud storage interface capable of exchanging data between the at least one storage cloud and a public cloud storage service on the Internet.

20. A computer program product, comprising a computer usable medium having a computer readable program code embodied therein, said computer readable program code adapted to be executed to implement a private storage cloud, said method comprising:
deploying, at a host computer having with a data storage medium, one or more network adapters, an operating system and a file system, a user interface to a private cloud storage system; and
controlling through the user interface the settings of the host computer's file system or operating system to maintain a storage cloud having at least one volume for data stored within the host computer's data storage medium.

21. A computer program product, comprising a computer usable medium having a computer readable program code embodied therein, said computer readable program code adapted to be executed to implement a hybrid storage cloud, said method comprising:
deploying, at a host computer having a data storage medium, one or more network adapters, an operating system and a file system, a user interface to a hybrid cloud storage system;
controlling through the user interface settings of the host computer's file system or operating system to maintain a storage cloud having at least one volume for data stored within the host computer's data storage medium; and
configuring a public cloud storage interface system within the hybrid cloud storage system to interface with one or more third party public cloud storage services.

22. A method for implementing a private storage cloud comprising:
providing a locally connected cloud storage device;
connecting said locally connected cloud storage device to a network, said locally connected cloud storage device comprising
a data storage medium;
one or more network adapters, wherein the one or more network adapters are capable of connecting the cloud storage device to a network;
a file system;
an operating system, wherein the operating system and file system are capable of providing an end user access to at least one storage cloud having at least one volume for data stored in the data storage medium; and
a user interface capable of receiving commands reflecting desired settings for the end user and the volume, wherein the user interface, upon receiving a command reflecting desired settings, interacts with the file system and the operating system to effectuate the desired settings; and
providing end users access to at least one storage cloud having at least one volume for datastored in the locally connected cloud storage device's data storage medium.
